(19) United States
(12) Patent Application Publication
(10) Pub. No.: US 2008/0175254 A1
(43) Pub. Date: Jul. 24, 2008

(54) Method of learning address in Virtual LAN system

(75) Inventor: Chien-Ho Ho, Hsinchu (TW)

Correspondence Address: BACON & THOMAS, PLLC, 625 SLATERS LANE, FOURTH FLOOR, ALEXANDRIA, VA, 22314, US

(73) Assignee: Alpha Nerworks Inc., Hsinchu (TW)

(21) Appl. No.: 11/655,903

(22) Filed: Jan. 22, 2007

(51) Int. Cl. H04L 12/28

(52) U.S. Cl. 370/395.53; 370/392; 370/401

(57) ABSTRACT

The present invention is to provide a method of learning address in a VLAN system, which includes a plurality of network switching devices each connecting to at least one client VLAN and at least one server VLAN. Each of the network switching devices includes a forwarding database set therein, which includes at least a client VLAN forwarding table and at least one server VLAN forwarding table. When a network switching device receives a data packet from one of the client VLANs or the server VLANs, the network switching device firstly reads a source address contained in the data packet, and then learns the source address and stores the source address into a client VLAN or server VLAN forwarding table that matches the client VLAN or the server VLAN, and into a server VLAN forwarding table or all client VLAN forwarding tables that matches the server VLAN corresponding to the client VLAN or the client VLAN of the server VLAN. In such a way, flooding will not happen when transferring data packets either in a single network switching device, or among multiple network switching devices.

### FIELD OF THE INVENTION

The present invention relates to a method of learning address in a VLAN system, more particulary to a method enabling a network switching device to learn a source address contained in a data packet received from one of client VLANs and store the source address into a client VLAN forwarding table that matches the client VLAN.

### BACKGROUND OF THE INVENTION

As the network world booming, various network equipments are being continuously developed and widely involved in almost everywhere of human beings' daily life and routine jobs. Such a trend not only speeds up data communication, but also brings great convenience to people's daily life and routine jobs. At present, local area network (LAN) or internet are used by many enterprises for internal or external data transmittance. However, more and more network equipments also bring many management problems to network managing staff. Therefore, to allow the network managing staff efficiently managing a plurality of network equipments becomes a great concern in the art for improvement.

A Virtual LAN (VLAN), also known as a logical LAN, is that uses specific technology to logically connect different workstations that are probably not physically connected, so that communication among these workstations performs as they are physically connected. An outstanding characteristic of VLANs is that typically, a VLAN is an independent broadcast domain, which means in a single VLAN, broadcast packets emitted from any workstation can be only broadcasted to all members of the same VLAN, without broadcasting to other VLANs. As such, safety of network communication can be improved by limiting communication ranges of all members of a VLAN with this single VLAN, and thus possibility of being hacked by workstations of other VLANs can be reduced.

Generally, a conventional VLAN system uses a non-tagged aware switch, and VLAN functions can be carried out by dividing connection ports of the switch into various flooding ports. As shown in FIG. 1, such a switch 10 is respectively connected to a first VLAN 11, a second VLAN 12, and a server VLAN 13. The first VLAN 11 includes connection ports of a first workstation 111, connection ports of a second workstation 112, and connection ports of a third workstation 113. The second VLAN 12 includes connection ports of a fourth workstation 121, and connection ports of a fifth workstation 122. The server VLAN 13 includes connection ports of a server 131, and connection ports of workstations 111, 112, 113, 121, 122, respectively.

When the switch 10 receives an unknown packet or broadcast packet from the first workstation 111, the unknown packet or broadcast packet will be flooded by the switch 10 to the second workstation 112, the third workstation 113 and the server 131. When the switch 10 receives an unknown packet or broadcast packet from the fourth workstation 121, the unknown packet or broadcast packet will be flooded by the switch 10 to the workstations 111, 112, 113, 121, and 122. In such a way, workstations of the first VLAN 11 are incapable of exchanging information with workstations of the second VLAN 12 by identifying different flooding domains. As such, information from each VLAN can be kept confidential.

Unfortunately, the conventional VLAN system has a serious weakness in secret protection, so that the foregoing-described secrecy becomes almost invalid. For example, if a client of the first workstation 111 is aware of media access control address (MAC address) used by the fourth workstation 121, the client of the first workstation 111 may use an approach of unicast to transmit a unicast packet to the fourth workstation 121 via the server 131. Such is a big breach of information security.

The new generation of network technology provides a technology of independent VLAN learning, which is also know as IVL mode, applied to VLAN systems. The IVL mode is so named because MAC addresses learned by a certain VLAN can not be used by other VLANs. Because the client and the server belong to different VLANs, the packets thereof are not communicable. As such, employing a router is a must to allow the client getting in connection with the server.

In order to solve the communication problem between the client and the server without employing a router, a solution is proposed to repeatedly learn the source addresses in a plurality of VLANs. As shown in FIG. 2, the switch 10 includes a first connection port 101, a second connection port 102, a third connection port 103, a fourth connection port 104, and a fifth connection port 105. The first connection port 101 and the second connection port 102 belong to the first VLAN 11. The third connection port 103 and the fourth connection port 104 belong to the second VLAN 12. All of these connection ports 101, 102, 103, 104, and 105 belong to the server VLAN 13, and are untagged connection ports.

When the first connection port 101 receives an untagged packet from a workstation A, because the first connection port is an untagged connection port of the first VLAN 11 and the server VLAN 13, a MAC address of the workstation A is then learnt and stored into forwarding tables of the first VLAN and the server VLAN 13 respectively. Similarly, when the fifth connection port 105 receives an untagged packet form a server X, a MAC address of the server X is then learnt and stored into forwarding tables of the first VLAN 11, the second VLAN 12, and the server VLAN 13 respectively. When the fifth connection port 105 receives an untagged packet from the workstation B, a MAC address of the workstation B is then learnt and stored into forwarding tables of the second VLAN 12 and the server VLAN 13 respectively. As such, the workstation A is incapable of transmitting any packet to the workstation B, because the MAC address is not listed in the forwarding table of the first VLAN 11. Therefore, the foregoing breach of information security of conventional VLANs can be remedied.

However, although this approach is a solution for the breach of information security, it is applied to a single switch, and cannot be used in a VLAN environment containing multi-switches, because packets are transferred between different switches in tagged form. Suppose the switch 10 transfers packets to other switches by via a sixth connection port 106 configured thereon, and the sixth connection port 106 is a tagged connection port of the first VLAN 11, the second VLAN 12 and the server VLAN 13, respectively, and if the sixth connection port 106 receives a packet from another switch for transferring to the server X, because the packet is tagged, the MAC address of the tagged packet cannot be learnt and stored into the forwarding table of the server VLAN. As such, when the server X feeds back a reply packet, flooding happens again that may puzzle other clients of the VLAN.

### SUMMARY OF THE INVENTION

In view of the foregoing shortcomings of the prior art, the inventor of the present invention based on years of experience to conduct extensive researches and experiments and finally invented a method of learning address in a VLAN system for remedying the breach in information security, and preventing flooding happened in VLAN systems.

Therefore, it is a primary objective of the present invention to overcome the foregoing shortcomings by providing a method of learning address in a VLAN system. The VLAN system includes a plurality of network switching devices, a plurality of client VLANs, and a plurality of server VLANs. Each of the network switching devices is connected to at least one client VLAN and at least one server VLAN. Each of the network switching devices includes a forwarding database set therein, the forwarding database including at least a client VLAN forwarding table and at least one server VLAN forwarding table. When a network switching device receives a data packet from one of the client VLANs, the network switching device firstly reads a source address contained in the data packet, and then stores the source address into a client VLAN forwarding table that matches the client VLAN and into a server VLAN forwarding table that matches the server VLAN corresponding to the client VLAN. When the network switching device receives a data packet from one of the server VLANs, the network switching device firstly reads a source address contained in the data packet, and then stores the source address into a VLAN forwarding table that matches the server VLAN, and into all client VLAN forwarding tables that match the client VLAN of the server VLAN. In such a way, flooding will not happen when transferring data packets either in a single network switching device, or among multiple network switching devices.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of a conventional VLAN;

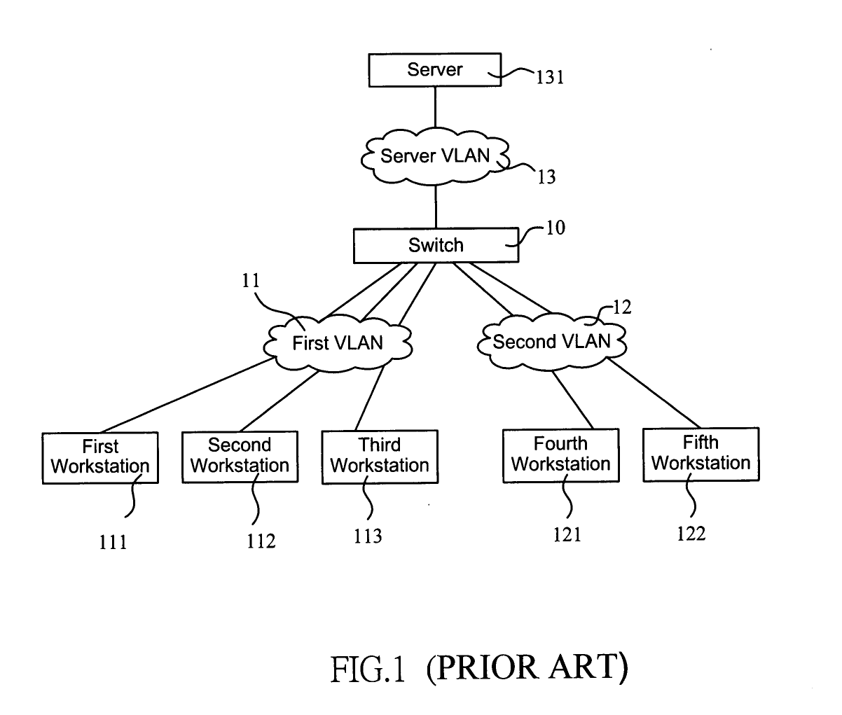

FIG. 2 is a schematic view of another conventional VLAN;

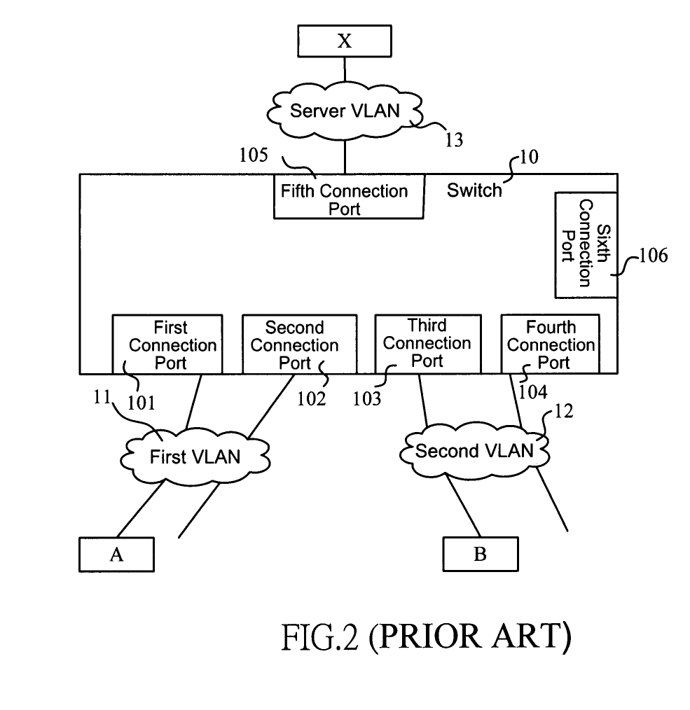

FIG. 3 is a schematic view of a VLAN according to an embodiment of the present invention;

FIG. 4 is a flow chart of a preferred embodiment of method according to the present invention; and

FIG. 5 is another flow chart of a preferred embodiment of method according to the present invention.

### DETAILED DESCRIPTION OF THE PREFERRED EMBODIMENTS

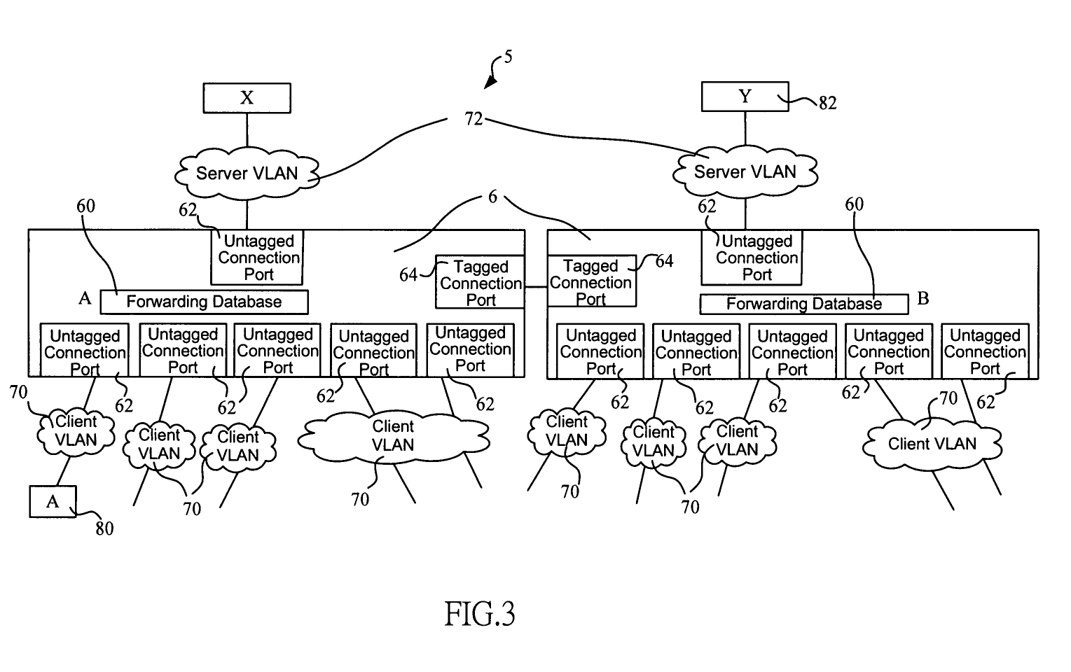

Referring to FIG. 3 for a method of learning address in a VLAN system, the method is applied to a VLAN system 5. The VLAN system 5 includes a plurality of network switching devices 6. Each network switching device 6 is connected to at least one client VLAN 70 and at least one server VLAN 72. Each network switching device 6 has a forwarding database 60 set therein, and the forwarding database 60 includes at least one client VLAN forwarding table and at least one server VLAN forwarding table. Each client VLAN forwarding table matches a client VLAN 70, and each server VLAN forwarding table matches a server VLAN 72.

When a network switching device 6 receives a data packet from one of the client VLANs 70, the network switching device 6 firstly reads a source address contained in the data packet, and then stores the source address into a client VLAN forwarding table that matches the client VLAN 70 and into a server VLAN forwarding table that matches the server VLAN 72 corresponding to the client VLAN 70. When the network switching device 6 receives a data packet from one of the server VLANs 72, the network switching device 6 firstly reads a source address contained in the data packet, and then stores the source address into a VLAN forwarding table that matches the server VLAN 72, and into all client VLAN forwarding tables that match the client VLAN 70 of the server VLAN 72. In such a way, every network switching devices 6 gets known about the source address of the all data packets, and thus no matter the packets are transferred within a single network switching device 6 or among multiple switching devices 6, flooding will not happen

According to an embodiment of the present invention, and referring to FIG. 3, each of the network switching devices 6 for example can be a switch. Each network switching device 6 has a plurality of untagged connection ports 62 configured thereon. Each of the untagged connection ports 62 is applied to connection with the client VLAN 70 or the server VLAN 72. A plurality of untagged connection ports 62 can be connected to a single client VLAN 70. In this way, the untagged connection ports 62 receive the data packets transferred from the client VLAN 70 connected thereto. Further, each of the network switching devices 6 has a plurality of tagged connection ports 64 configured thereon. The tagged connection ports 64 are applied to connecting one network switching device 6 with another network switching device 6. The tagged connection ports 64 may belong to various network switching devices 6, so that packets of a same VLAN can be communicable when transferring between various network switching devices 6.

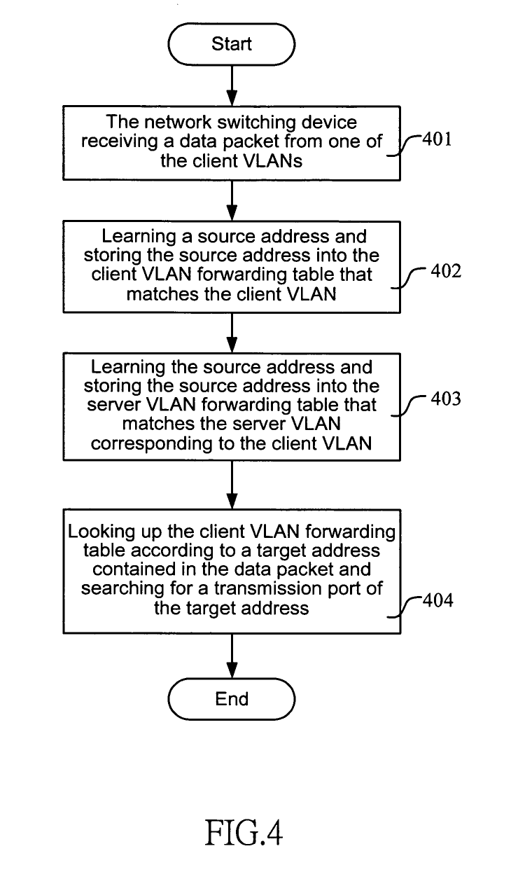

For better illustrating the method of learning address in a VLAN system according to the present invention, referring to FIG. 4, the method processes the following steps:
(401) the network switching device 6 receiving a data packet from one of the client VLANs 70, wherein the packet may be transferred from the untagged connection ports 62 or the tagged connection ports 64, and the network switching device 6 is capable of reading the source address contained in the data packet. According to the embodiment, the source address is a media access control address (MAC address) of an operation device 80 that emits the data packet. Because whenever the network switching device 6 receives a data packet transferred from a certain VLAN, the source address of the data packet has to be compared with addresses recorded in the forwarding table of the forwarding database, therefore whenever learning or transmitting the data packet, the source address thereof must be firstly read out.
(402) learning a source address and storing the source address into the client VLAN forwarding table that matches the client VLAN 70, wherein if the source address is already existed in the client VLAN forwarding table, the learning operation can be skipped;
(403) learning and storing the source address into the server VLAN forwarding table that matches the server VLAN 72 corresponding to the client VLAN 70, wherein if the source address is already existed in the server VLAN forwarding table, the learning operation can be skipped; and
(404) looking up the client VLAN forwarding table according to a target address contained in the data packet and searching for a transmission port of the target address, and if the transmission port of the target address is obtained, then transmitting the data packet to the transmission port; and if the transmission port of the target address cannot be obtained, then flooding the data packet to all connection ports of the client VLAN 70.

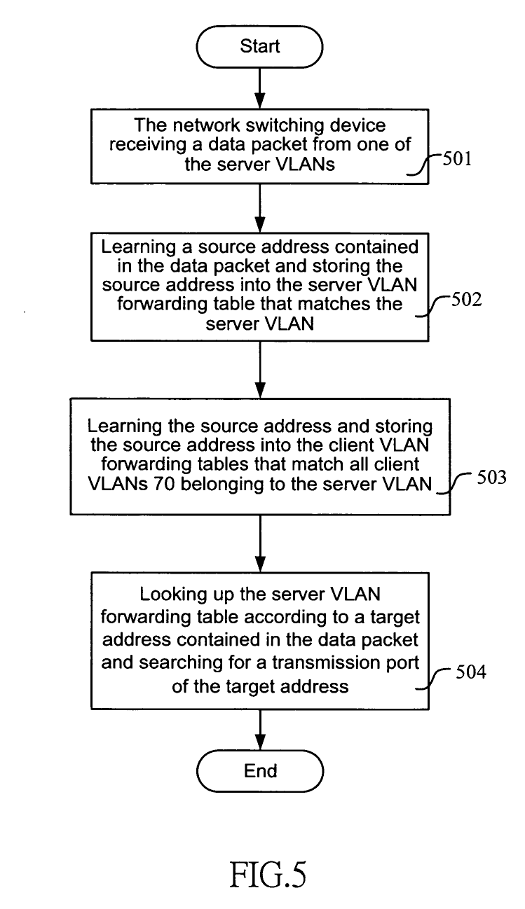

However in another situation, referring to FIG. 5, the method of learning address in a VLAN system of the embodiment according to the present invention processes the following steps:
(501) the network switching device 6 receiving a data packet from one of the server VLANs 72, wherein the packet may be transferred from the untagged connection ports 62 or the tagged connection ports 64, and the network switching device 6 is capable of reading the source address contained in the data packet;
(502) learning a source address contained in the data packet and storing the source address into the server VLAN forwarding table that matches the server VLAN 72, wherein if the source address is already existed in the server VLAN forwarding table, the learning operation can be skipped;
(503) learning and storing the source address into the client VLAN forwarding tables that match all client VLANs 70 belonging to the server VLAN 72, wherein if the source address is already existed in the client VLAN forwarding tables, the learning operation can be skipped; and
(504) looking up the server VLAN forwarding table according to a target address contained in the data packet and searching for a transmission port of the target address, and if the transmission port of the target address is obtained, then transmitting the data packet to the transmission port; and if the transmission port of the target address cannot be obtained, then flooding the data packet to all connection ports of the server VLAN 72.

As such, except the first time transportation, flooding will not happen after the network switching device 6 learning the source address of a request packet and storing the same into a suitable VLAN forwarding table, and after learning the source address of a reply packet, i.e., the target address of the request packet, and storing the same into a suitable VLAN forwarding table.

An example is given hereby for illustrating the situation of the data packet being learnt and the flow of the data being transferred, according to the method of learning address in a VLAN system of the present invention. Referring to FIG. 3 again, supposing that a MAC address of the operation device of a client is “P1 MAC”; a client VLAN corresponding to the operation device 80 has an identification code V1; and a MAC address of a server 82 to which the packets will be transferred is “Y MAC”; a server VLAN corresponding to the server 82 has an identification code V20, when the operation device 80 of the client is connected to a first connection port 62 of the network switching device A, “P1 MAC and V1” and “P1 MAC and V20” will be learnt. When the data packet is transferred to another network switching device B via a tagged connection port 64 of the network switching device A, “P1 MAC and V1” and “P1 MAC and V20” will be learnt, and the data packet will be transferred to the server 82.

When a reply packet corresponding thereto is transferred back from the server 82 via the server VLAN 72 to the network switching device B, “Y MAC and V20”, “Y MAC and V1”, and “Y MAC and V2” will be learnt. After obtaining “P1 MAC and V20”, the network switching device B transfers the reply packet back to the network switching device A, and then the network switching device A learns “Y MAC and V20”, “Y MAC and V1”, and “Y MAC and V2” again and transfers the reply packet back to the operation device 80 via the first connection port 62. In such a way, the problem of conventional VLAN systems of flooding a data packet to all connection ports when finding no target address thereof and the puzzles caused to other clients can be completely remedied.

In summary, the method according to the present invention has the following advantages:
1. conventional VLAN systems must use expensive layer 3 network equipments for avoiding flooding problems, while by the method according to the present invention, the flooding problem can be remedied in facilitation with only layer 2 network equipments, that drastically saves cost;
2. the method according to the present invention greatly promotes information security and secrecy, which performance is much better than a conventional layer 3 routing technology that transmits packets along defined routes; and
3. the network switching device 6 has a learning functionality, by which the integrality and correctness of the forwarding database can be well maintained, and such a forwarding database can be relied on for providing required data for network connection to host terminals on the network, and even refreshing data of other network switching devices.

While the invention herein disclosed has been described by means of specific embodiments, numerous modifications and variations could be made thereto by those skilled in the art without departing from the scope and spirit of the invention set forth in the claims.

What is claimed is:

1. A method of learning address in a VLAN system, applied to a plurality of network switching devices of a VLAN system, each of the network switching devices being connected to at least one client VLAN and at least one server VLAN, wherein each of the network switching devices has a forwarding database set therein, the forwarding database comprising at least a client VLAN forwarding table and at least one server VLAN forwarding table, the method comprising the following steps:
the network switching device receiving a data packet from one of the client VLANs;
learning a source address contained in the data packet and storing the source address into the client VLAN forwarding table that matches the client VLAN; and
learning the source address and storing the source address into the server VLAN forwarding table that matches the server VLAN corresponding to the client VLAN.

2. The method as set forth in claim 1 further comprising the following steps:
the network switching device receiving a data packet from one of the server VLANs;
learning a source address contained in the data packet and storing the source address into the server VLAN forwarding table that matches the server VLAN; and
learning the source address and storing the source address into the client VLAN forwarding tables that match all client VLANs belonging to the server VLAN.

3. The method as set forth in claim 1, wherein after the step of learning the source address to the server VLAN forwarding table that matches the server VLAN corresponding to the client VLAN, the method further comprises the steps of:
looking up the client VLAN forwarding table according to a target address contained in the data packet; and
finding a transmission port of the target address and then transmitting the data packet to the transmission port.

4. The method as set forth in claim 3, wherein if the transmission port of the target address cannot be found, then the data packet is flooded to all connection ports of the client VLAN.

5. The method as set forth in claim 2, wherein after the step of learning the source address to the client VLAN forwarding tables that match all client VLANs belonging to the server VLAN, the method further comprises the steps of:
looking up the server VLAN forwarding table according to a target address contained in the data packet; and
finding a transmission port of the target address and transmitting the data packet to the transmission port.

6. The method as set forth in claim 5, wherein if the transmission port of the target address cannot be found, then the data packet is flooded to all connection ports of the server VLAN.

7. The method as set forth in claim 4, wherein the source address is a MAC address of a network device to which the data packet is to be transferred.

8. The method as set forth in claim 6, wherein the source address is a MAC address of a network device to which the data packet is to be transferred.

9. The method as set forth in claim 4, wherein the source address is a MAC address of a network device which emits the data packet.

10. The method as set forth in claim 6, wherein the source address is a MAC address of a network device which emits the data packet.
